(19) United States
(12) Patent Application Publication
(10) Pub. No.: US 2025/0381718 A1
(43) Pub. Date: Dec. 18, 2025

(54) FABRICATING RUBBER LINING FOR COMPOSITE PCP STATOR

(71) Applicant: Schlumberger Technology Corporation, Sugar Land, TX (US)

(72) Inventors: Maxim Pushkarev, Lawrence, KS (US); Peter Hondred, De Soto, KS (US); Jason Holzmueller, Lawrence, KS (US); William Goertzen, Lawrence, KS (US)

(21) Appl. No.: 18/878,187

(22) PCT Filed: Jun. 22, 2023
(86) PCT No.: PCT/US2023/025991

§ 371 Date: Dec. 23, 2024

Related U.S. Application Data
(60) Provisional application No. 63/366,880, filed on Jun. 23, 2022.

(51) Int. Cl. B29C 48/00; B29C 48/08; B29C 65/00; B29C 65/48; B29C 65/54; B29K 21/00; B29L 23/00; B29L 31/00; C08J 3/24

(52) U.S. Cl. CPC B29C 48/0021; B29C 48/0019; B29C 48/08; B29C 65/4835; B29C 65/54; B29C 66/61; C08J 3/247; B29K 2021/003; B29L 2023/005; B29L 2031/7496; C08J 2321/00

(57) ABSTRACT

Techniques for forming a helical rubber hose are provided. Such techniques include modified crosshead extrusion techniques in which an elastomer is melted, fed into a crosshead assembly, and extruded on a helical mandrel fed through the crosshead assembly to form a hose. In techniques described herein, relative axial and rotational motion of the mandrel and a die plate at or on the outlet or output of the crosshead assembly are kinematically matched such that the distance of relative axial movement of the mandrel per one revolution equals one pitch of the mandrel.

### CROSS REFERENCE PARAGRAPH

This application claims the benefit of U.S. Provisional Application No. 63/366,880, entitled “FABRICATING RUBBER LINING FOR COMPOSITE PCP STATOR,” filed Jun. 23, 2022, the disclosure of which is hereby incorporated herein by reference.

### FIELD

The present disclosure generally relates to stators and methods of making the same, and more particularly to stators for progressive cavity pumps and methods of making the same.

### DESCRIPTION OF THE RELATED ART

Oil and gas wells utilize a borehole drilled into the earth and subsequently completed with equipment to facilitate production of desired fluids from a reservoir. Subterranean fluids, such as oil, gas, and water, are often pumped or “lifted” from wellbores by the operation of downhole pumps, for example progressive cavity pumps (PCPs). A PCP includes a single rotor having a helical external surface that rotates inside a helical double-lobe elastomer lining formed into the coupled stator. In use, fluid is displaced from the intake at the bottom of the pump to the discharge at the top through a series of cavities that form between the rotor and stator as the rotor rotates within the stator. A motor drives rotation of the rotor. The motor can be located at the surface of the wellbore, and may be connected to the rotor via one or more sucker rods. Alternatively, the PCP rotor can be driven by a motor submersed downhole.

### SUMMARY

In some configurations, a method of forming a hose includes: melting an elastomer; providing the melted elastomer to a crosshead assembly, wherein a die plate having an outlet port is mounted on an outlet of the crosshead assembly; moving a helical mandrel through the crosshead assembly and die plate outlet port while extruding the melted elastomer about the mandrel; and kinematically correlating relative axial and rotational movement between the mandrel and the die plate.

In some configurations, a helical hose is formed by such a method. In some configurations, the helical hose is incorporated into a stator for a progressive cavity pump or a positive displacement motor.

In some configurations, the mandrel is rotationally fixed and the die plate is configured to rotate about a longitudinal axis along which the mandrel extends through the die plate. In some such configurations, kinematically correlating relative axial and rotational movement between the mandrel and the die plate includes axially moving the mandrel a distance equal to one pitch of the mandrel as the die plate rotates one revolution. In some configurations, the die plate is rotationally fixed and the mandrel is configured to rotate about its longitudinal axis. In some such configurations, kinematically correlating relative axial and rotational movement between the mandrel and the die plate includes rotating the mandrel about its longitudinal axis 360° as the mandrel travels axially a distance equal to one pitch of the mandrel.

The elastomer can be rubber. Extruding the melted elastomer about the mandrel can include extruding the melted elastomer through a gap between an outer diameter of the mandrel and an inner diameter of the die plate outlet port.

In some configurations, a method for manufacturing a stator for a progressive cavity pump includes: forming a helical hose; inserting the helical hose into a stator tube; and filling a gap between an outer diameter of the helical hose and an inner diameter of the stator tube with a material.

The material can be a thermoset resin. The method can further include curing or vulcanizing the thermoset resin to solidify and bond the material to the helical hose. The helical hose can be made of rubber. The helical hose can be formed about a mandrel, and the method can further include removing the mandrel from the helical hose.

In some configurations, a method of curing a rubberized mandrel includes applying a protective layer over the rubberized mandrel; surrounding the rubberized mandrel with a slurry or sand/binder mixture; allowing the slurry to solidify, thereby creating a shell about the rubberized mandrel; heating the rubberized mandrel and shell to cure the rubber; and washing away or crushing the shell formed by the solidified slurry or sand/binder mixture.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 illustrates an example PCP system.

FIG. 2 shows a transverse cross-section of a cPCP stator.

FIG. 3 shows a perspective 3D view of a portion of a rubbing lining of the cPCP stator.

FIG. 4 shows various aspects of a crosshead over mandrel extrusion technique.

FIG. 5A shows a partial longitudinal cross-section of a helical rubber hose formed on or about a helical mandrel.

FIG. 5B shows a partial perspective 3D view of the rubber hose and mandrel of FIG. 5A.

FIG. 6 shows an example technique for forming a helical rubber hose.

FIG. 7 shows another example technique for forming a helical rubber hose.

FIG. 8 shows an example ball transfer bearing.

FIG. 9 shows another example technique for forming a helical rubber hose.

FIGS. 10-11 show possible defects that can occur after improper curing.

FIG. 12 shows steps for making a single use shell to be used for curing a rubberized mandrel.

FIG. 13 shows an alternative mold.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

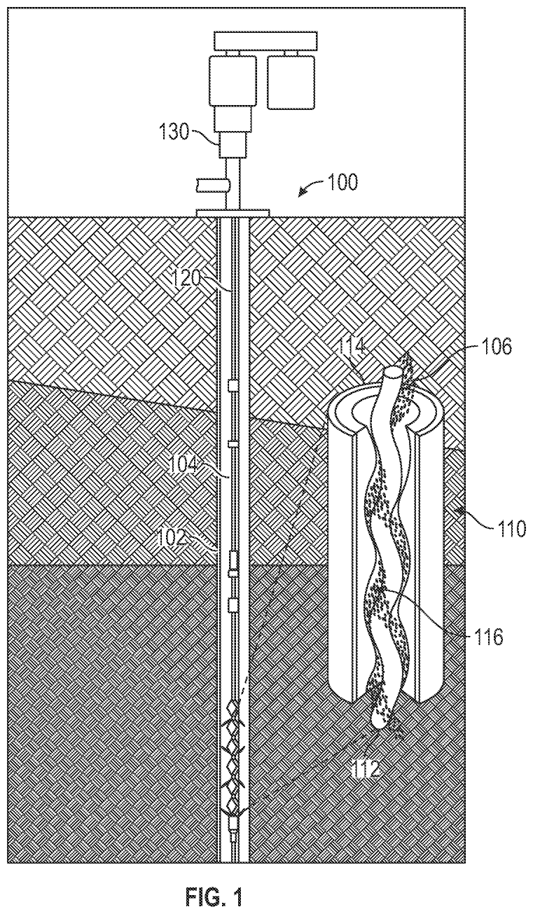

FIG. 1 illustrates an example PCP system 100. As shown, the PCP system 100 includes a pump (i.e., a PCP) 110, one or more sucker rods 120, and an electric motor 130. The PCP 110 includes a single helical rotor 112 that rotates inside a double helical stator 114 in use. During operation, fluid 106 is transferred from an intake at the bottom of the pump 110 to a discharge or outlet at the top of the pump 110 through a series of cavities 116 that form between the rotor 112 and stator 114 as the rotor 112 rotates,, within the stator 114.

In use, the PCP 110 is disposed downhole in a borehole lined with a well casing 102. The electric motor 130 is disposed at the surface of the well. The sucker rods 120 extend between and connect (e.g., physically and/or operatively connect) surface components of the system 100, such as the electric motor 130, and downhole components of the system 100, such as the PCP 110. Each sucker rod 120 can be threaded at one or both ends to enable threaded connections with other components, such as the PCP 110 (i.e., the rotor 112), surface component(s), and/or other sucker rods 120. In use, the motor 130 rotates or causes rotation of the sucker rods 120, which in turn rotate or cause rotation of the rotor 112. Production tubing 104 can be disposed in the borehole to convey pumped fluids 106 discharged from the outlet of the PCP 110 to the surface. In the illustrated configuration, the tubing 104 is disposed around or surrounds the sucker rods 120.

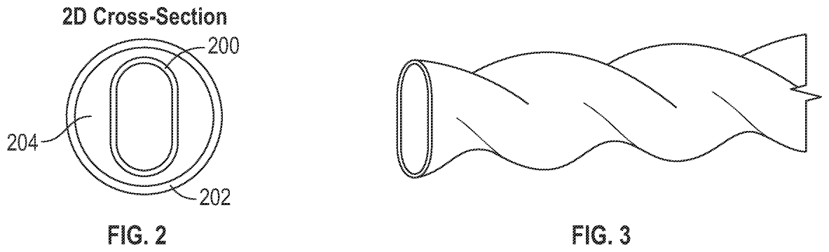

The present disclosure relates to manufacturing methods for producing a composite PCP stator, or cPCP stator. FIG. 2 shows a transverse cross-section of an example cPCP stator. As shown, the cPCP stator has an inner rubber lining or layer, an outer metal tube, and thermoset resin between (e.g., radially between) the rubber lining and the metal tube.

A method or process for manufacturing a cPCP stator can include: fabricating a rubber hose that will become a rubber lining of the stator; placing the rubber hose over, around, or about a mandrel, e.g., a metallic mandrel (or inserting the mandrel in the hollow rubber hose); inserting the mandrel with rubber hose into a metal stator tube; filling a gap between the rubber hose OD (outer diameter) and stator tube ID (inner diameter), for example, with thermoset resin; and curing (e.g., vulcanizing) the thermoset resin (or other material used to fill the gap) to solidify and bond the material to the rubber hose; and removing the mandrel from the cPCP stator. The rubberized mandrel can be fabricated such that the rubber thickness is precisely controlled and there are no adhesive or cohesive elements between the mandrel and the rubber hose formed over it.

The present disclosure provides methods for fabricating a helically shaped rubber hose in an accurate and controllable manner. In some configurations, a crosshead extrusion technique allows rubber to be formed into a desired helical shape. The rubber can remain on the mandrel during that process. The technique utilizes an axially movable mandrel and involves kinematically matching rotation between the mandrel OD (outer diameter), which forms the rubber hose ID (inner diameter), and a die plate that forms the rubber hose OD. An axial movement of the mandrel for one pitch matches a single revolution relative to the die place, which may be a rotatable or non-rotatable feature.

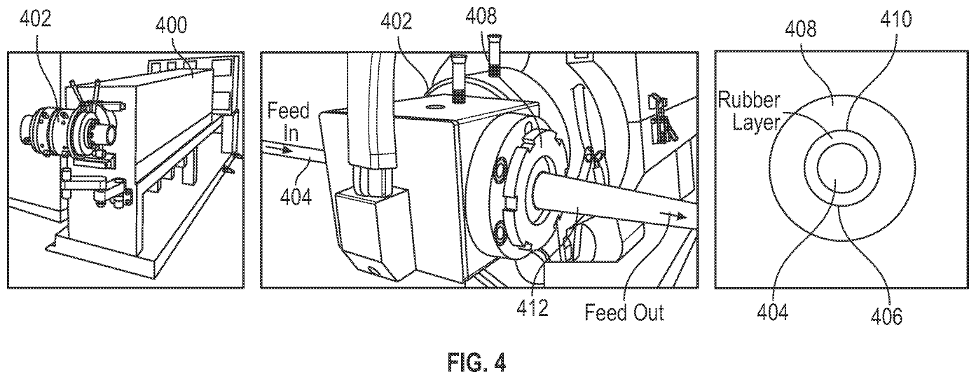

Methods according to the present disclosure can be based on or share some features with a traditional crosshead over mandrel extrusion technique, for example as illustrated in FIG. 4. An elastomer (e.g., a synthetic or natural rubber) is preheated and melted in a high-pressure extrusion machine (or extruder). The rubber melt is fed into a crosshead assembly. Crosshead extrusion is often used to make cylindrical rubber rollers. A rigid mandrel (often made of metal) is pushed through the crosshead assembly. To form a cylindrical rubber roller, the mandrel is cylindrical. In the crosshead assembly, uncured rubber envelops the mandrel OD and is readied for extrusion. The mandrel is moved axially through a hollow die plate mounted on or at the crosshead assembly outlet. Simultaneously, rubber melt is pushed through a gap between the mandrel OD and an ID of an outlet of the die plate. This process forms a uniform rubber layer enveloping the mandrel OD.

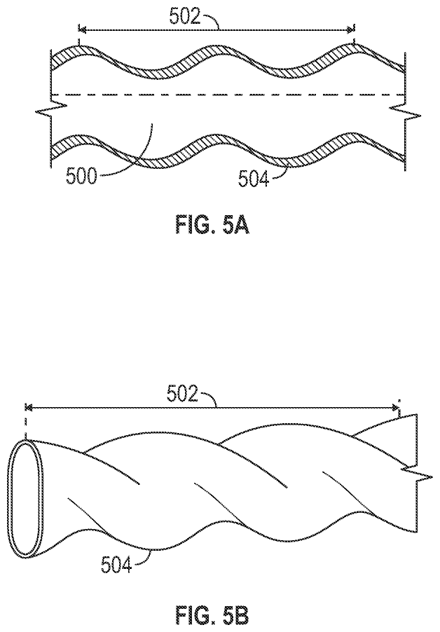

According to the present disclosure, this crosshead over mandrel extrusion technique is modified to form a helical rubber hose, for example as shown in FIG. 3. In techniques according to the present disclosure, the mandrel is helical, as shown in FIGS. 5A-7. The mandrel can thought of or similar to a double-lead or double-start screw, in other words, having two starts. One mandrel pitch (or lead) corresponds to, equals, or approximately or substantially equals one pitch of the helical rubber hose formed by techniques according to the present disclosure, as shown in FIGS. 5A and 5B. In other words, if the mandrel was threaded with an imaginary nut, the pitch could be defined as the axial distance the nut travels along the mandrel with or during one revolution of the nut.

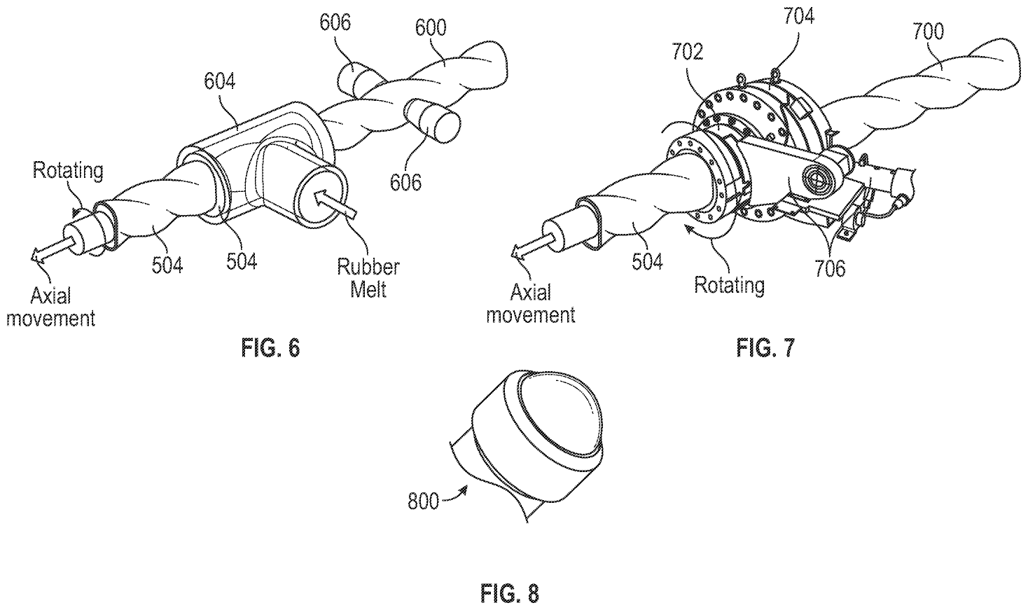

Techniques according to the present disclosure introduce a rotational degree of freedom to the mandrel and/or the die plate during the extrusion process. Techniques according to the present disclosure also includes a kinematic link between axial movement of the mandrel and (1) rotation of the mandrel relative to a non-rotatable die plate or (2) rotation of the die plate relative to a non-rotatable mandrel. In the case of (1) (rotation of the mandrel relative to a non-rotatable die plate, for example as shown in FIG. 6), the mandrel is rotated about its longitudinal axis 360° as the mandrel travels (through the crosshead assembly and die plate) an axial distance equal to one mandrel pitch. In the case of (2) (rotation of the die plate relative to a non-rotatable mandrel, for example as shown in FIG. 7), the die plate is rotated about its longitudinal axis (an axis extending through the die outlet port and along with the mandrel extends and travels as the mandrel moves through the crosshead assembly and die plate during extrusion) 360° as the mandrel travels an axial distance equal to one mandrel pitch.

In techniques in which the mandrel rotates relative to a stationary die plate, for example as shown in FIG. 6, guiding pins can be included and used to provide or ensure the proper kinematic match or interaction between the mandrel and die plate. The guiding pins are anchored to a stationary unit or piece of equipment, for example, to the extruder or to a separate assembly mounted to a floor. In the illustrated configuration, two guiding pins are included. Tips of the pins are in constant contact with the mandrel's flanks during extrusion, inducing friction forces on the mandrel and causing motion of the mandrel. If the mandrel bas a relatively shallow pitch, the primary load(s) applied to the mandrel during extrusion should move the mandrel axially through the crosshead assembly. In such cases, the pins cause rotational motion of the mandrel. If the mandrel has a relatively steep pitch, the primary load(s) applied to the mandrel during extrusion should rotate the mandrel. In such cases, the pins cause the mandrel to travel axially. In some configurations, the tips of the pins can be designed as ball transfer bearings, for example as shown in FIG. 8. In some configurations, the pins can be replaced with a customized roller aligned with the mandrel's helix.

In techniques in which the die plate rotates relative to a non-rotatable mandrel, for example as shown in FIG. 7, the mandrel is non-rotatable and is pushed or pulled axially through the crosshead assembly. The die plate is mounted on a rotatable die at or on an outlet or output of the crosshead assembly. The RPM of the die is correlated to the axial velocity of the mandrel such that one revolution of the die corresponds to an axial movement of the mandrel equal to one pitch.

Other variations of techniques, for example, other kinematic schemes, according to the present disclosure are also possible. For example, the mandrel can be axially fixed and non-rotatable, while the die plate is axially moveable and rotatable, such that the die plate rotates and moves axially relative to the stationary mandrel. As another example, the mandrel can be rotatable, but axially fixed, while the die plate is axially moveable but non-rotatable, such that the mandrel rotates within the die plate as the die plate moves axially along or relative to the axially fixed mandrel. As another example, both the mandrel and die plate can be rotatable and axially moveable.

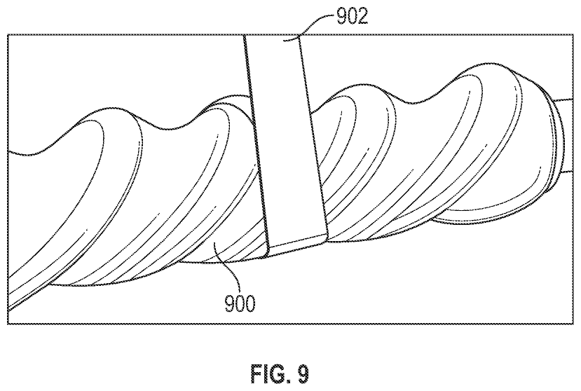

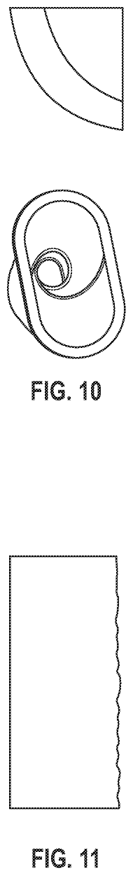

FIG. 9 illustrates an alternative method for rubberizing the mandrel. As shown in FIG. 9, the mandrel can be wrapped with a relatively thin tape made of a green (uncured) elastomer. A desired thickness of the rubber lining can be achieved by covering the mandrel with one or more layers of thin rubber stripes.

After extrusion (for example, as shown in and described with respect to FIGS. 6-7) or wrapping (for example, as shown in FIG. 9), the rubberized mandrel is cured. The temperature, time, pressure, and “boundary” constraints are key parameters for the curing process. Pressure is required to consolidate the rubber lining and achieve a monolithic material structure. Without sufficient pressure, various types of voids and delaminating defects can occur For example, FIG. 10 shows voids in a rubber hose due to the applied pressure being insufficient to consolidate the rubber. Boundary constraints prevent the rubber from distorting while curing and ensure the rubber lining achieves and maintains the desired shape. FIG. 11 illustrates distorted rubber extruded over a cylindrical mandrel due to lack of boundary constraints. While cylindrical rubberized mandrels can be wrapped with a special elastic tape to ensure the rubber lining is pressurized and not over-distorted during curing, such wrapping is not sufficient for the helical geometry of the present disclosure, as wrapping helicoidal mandrels does not allow for forming a uniformly tensioned tape layer.

In systems and methods according to the present disclosure, profiled rubberized mandrels are cured using a single use shell or mold that mimics the outer shape of an uncured elastomer layer deposited on a rigid mandrel. The shell is made of a special slurry or a sand/binder mixture. Such a free-flowing media allows for enveloping complex parts and solidification of the media.

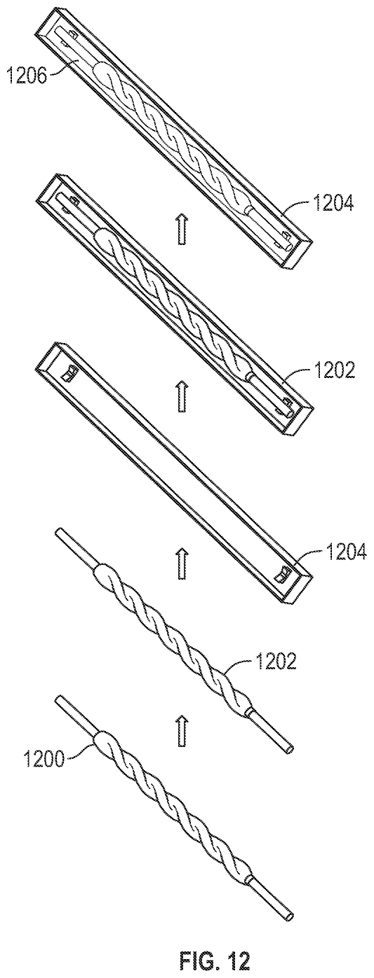

FIG. 12 illustrates steps for making such a shell. First, the rubberized mandrel is covered with a protective layer that is capable of withstanding the curing temperature (typically 150° C. or 300° F.), for example, by wrapping the mandrel with a PTFE tape. The tape tension does not need to be high and should not distort the green rubber. The mandrel with the protective layer is then placed in a bath or tray. The bath is filled with the special slurry, which may be the material Aquapour or a similar material. Aquapour is supplied as a powder and can be mixed with water to obtain a pourable slurry. A setting time of about 30-60 minutes, depending on water content, is needed to solidify the slurry. The slurry ultimately envelops the mandrel. After solidifying, the slurry creates a shell that follows or mimics the shape of the outer rubber surface.

The bath or tray is then placed in an oven for the curing process. The slurry shrinks during curing, creating pressure that consolidates the elastomeric layer. After curing, the bath or tray is removed from the oven and allowed to cool. The solidified slurry is washed away, for example with standard tap water. Finally, the protective layer is removed from the fully cured rubber layer.

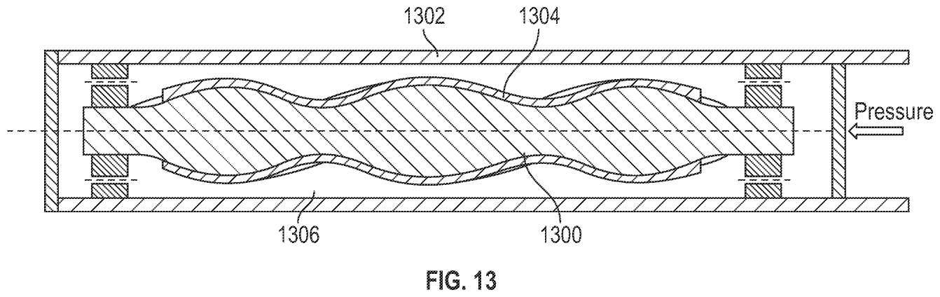

FIG. 13 illustrates an alternative mold. Instead of an open bath or tray, the rubberized mandrel can be placed in a tubular housing. Although not shown, the protective layer is still used. The space between the rubber layer and the housing ID is filled with a slurry or sand mixed with a binder. The mold of FIG. 13 and associated process can advantageously allow a very high pressure to be generated if needed and/or can allow the sand/binder mixture to be recyclable. After curing, the shell can be broken up and binder can be added to recover the solidifying properties.

The systems and methods shown in and described with respect to FIGS. 12-13 advantageously allow for application of a substantial pressure on green (uncured) rubber to ensure good quality elastomer structure and prevention of distorting rubber shape while curing.

Extrusion or manufacturing techniques according to the present disclosure can also or alternatively be used to manufacture articles other than PCP stators. For example, techniques according to the present disclosure can be used to manufacture stators for positive displacement motors (PDM), for example to be used for drilling operations. As another example, techniques according to the present disclosure can be used, or adapted to be used, to manufacture rotors (for example, PCP and/or PDM rotors). Extrusion techniques according to the present disclosure can be used to cover such rotors with rubber or plastic layers. In general, techniques according to the present disclosure can be used to manufacture helical tubes, which may be disposed within or about other components of an article.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A method of forming a hose, the method comprising:
melting an elastomer;
providing the melted elastomer to a crosshead assembly, wherein a die plate having an outlet port is mounted on an outlet of the crosshead assembly;
moving a helical mandrel through the crosshead assembly and die plate outlet port while extruding the melted elastomer about the mandrel; and
kinematically correlating relative axial and rotational movement between the mandrel and the die plate.

2. The method of claim 1, wherein the mandrel is rotationally fixed and the die plate is configured to rotate about a longitudinal axis along which the mandrel extends through the die plate.

2. The method of claim 2, wherein kinematically correlating relative axial and rotational movement between the mandrel and the die plate comprises axially moving the mandrel a distance equal to one pitch of the mandrel as the die plate rotates one revolution.

1. The method of claim 1, wherein the die plate is rotationally fixed and the mandrel is configured to rotate about its longitudinal axis.

4. The method of claim 4, wherein kinematically correlating relative axial and rotational movement between the mandrel and the die plate comprises rotating the mandrel about its longitudinal axis 360° as the mandrel travels axially a distance equal to one pitch of the mandrel.

1. The method of claim 1, wherein the elastomer is rubber.

7. The method of claim 1, wherein extruding the melted elastomer about the mandrel comprises extruding the melted elastomer through a gap between an outer diameter of the mandrel and an inner diameter of the die plate outlet port.

8. A helical hose formed by the method of claim 1.

9. A stator for a progressive cavity pump comprising the helical hose of claim 8.

10. A method for manufacturing a stator for a progressive cavity pump, the method comprising:
forming a helical hose;
inserting the helical hose into a stator tube; and
filling a gap between an outer diameter of the helical hose and an inner diameter of the stator tube with a material.

11. The method of claim 10, wherein the material is a thermoset resin.

12. The method of claim 11, further comprising curing or vulcanizing the thermoset resin to solidify and bond the material to the helical hose.

13. The method of claim 10, wherein the helical hose is rubber.

14. The method of claim 10, wherein forming the helical hose comprises the method of claim 1.

15. The method of claim 10, wherein forming the helical hose comprises forming the helical hose about a mandrel, and the method further comprises removing the mandrel from the helical hose.

16. A method of curing a rubberized mandrel, the method comprising:
applying a protective layer over the rubberized mandrel;
surrounding the rubberized mandrel with a slurry or sand/binder mixture;
allowing the slurry to solidify, thereby creating a shell about the rubberized mandrel;
heating the rubberized mandrel and shell to cure the rubber; and
washing away or crushing the shell formed by the solidified slurry or sand/binder mixture.
